(19) United States
(12) Patent Application Publication
(10) Pub. No.: US 2002/0062354 A1
(43) Pub. Date: May 23, 2002

(54) Method and apparatus for dynamic shared-memory caching of scripting engine product

(76) Inventors: Ze?apos;ev Suraski, Tel-Aviv (IL); Andi Gutmans, Tel-Aviv (IL)

Correspondence Address: SHIBOLETH YISRAELI ROBERTS & ZISMAN, LLP, 350 FIFTH AVENUE, 60TH FLOOR, NEW YORK, NY, 10118

(21) Appl. No.: 09/990,380

(22) Filed: Nov. 23, 2001

Related U.S. Application Data
(60) Provisional application No. 60/252,642, filed on Nov. 22, 2000.

(51) Int. Cl. G06F 15/167

(52) U.S. Cl. 709/212

(57) ABSTRACT

A network server in accordance with the present invention comprises shared memory and a cache mechanism for caching intermediate code files in said shared memory. The invention is particularly useful for Internet Web servers and for use with caching the intermediate code generated by scripts run by PHP scripting engines.

### CROSS-REFERENCE TO RELATED APPLICATION

In accordance with 35 USC §120, the present application claims the priority of the filing date of U.S. Provisional Application Ser. No. 60/252,642, filed Nov. 22, 2000, the entire contents of which are incorporated herein in their entirety.

### FIELD OF THE INVENTION

The present invention relates generally to programming for Web sites. More specifically, the present invention relates to a dynamic shared-memory cache for caching intermediate code generated by a scripting engine for use with PHP.

### BACKGROUND OF THE INVENTION

In general, a cache is a mechanism that stores, in a fast storage device for quicker repeated access, frequently requested data that for a variety of reasons may be slow to obtain from it's normal long term storage location or form. The reasons for trying to implement a cache include, speed of accessing the data from the hard drive, or length of time it takes to recompute the data each time it's requested or that the required data may be located at a network address that is slow to access. The idea is to make available a more readily accessible copy of the data and to keep it more on hand.

A cache hit refers to a request to obtain data which can be satisfied by reference to the cache contents, without resorting to reaccessing the system long term storage. When data is first read from, or written to long-term storage device, a copy is also saved in the cache, along with the associated long-term storage device address. The cache monitors addresses of subsequent reads to see if the required data is already in the cache. If it is a cache hit, then it is returned immediately and the long-term storage device read is aborted, i.e., not started. If the data is not cached, then it is fetched from long-term storage device, and also saved in the cache. This is a cache miss, which is a request to read from memory that cannot be satisfied from the cache, and for which the long-term storage device has to be consulted.

The most important characteristic of a cache is its hit rate—the fraction of all memory accesses, which can be satisfied from the cache. This in turn depends on the cache design parameters, for example its size relative to the long-term storage device. The size is usually limited by the cost of fast memory chips.

The hit rate also depends on the access pattern of the particular program being run i.e., the sequence of addresses being read and written. Caches rely on two properties of the access patterns of most programs: temporal locality—if something is accessed once, it is likely to be accessed again soon; and spatial locality—if one memory location is accessed, then nearby memory locations are also likely to be accessed.

The need for increased efficiency, adaptability and versatility as computer systems, networks and Web sites become more complex and provide greater interactivity and in response to heavier Web traffic has created greater demand for systems to provide better performance at the operating level.

As an example, it helps to discuss the development of one of the Internet's fastest growing Web site server side languages, PHP, which was created in 1994 by Rasmus Lerdorf to track “visits” to his online resume on his personal Web site. Today, most Web developers know that Web pages are more than pretty pictures and text Web sites strive to have some sort of animation or interactivity. Most of the higher end sites have features such as discussion forums, search engines and/or shopping carts. PHP enables developers to add dynamic features quickly.

One early approach to adding interactivity was to use Common Gateway Interface programs(CGI). A CGI is a program interface residing on a Web server. CGI allows Web pages to be linked to databases and other programs in such a way that data can be accessed by creating a query via the Web page, which is sent to a database management system for searching. Results are returned in Hypertext Markup Language (HTML) format for viewing by the searcher. Each new request to a CGI program requires the server to start a new process in the kernel, which uses both CPU time and memory, making CGI scripts increasingly slower. PHP solves this problem by becoming an integral part of the Web server itself, saving considerable load time. PHP also has extensive database support.

PHP is an embedded scripting language that can be placed into HTML documents, and as long as the Web server provides support, PHP can be used to generate HTML pages by contacting and accessing a database. PHP scripts presented in the form of source code, are executed on the server in response to requests sent by a remote users computer. When the PHP script is activated on the server, program files on the hard drive of the server are uploaded to the fast memory where they are translated and compiled into intermediate code which is used to generate a HTML or other type Web page response to send to the remote user's computer. The intermediate code is then discarded. Because PHP is open source, it is constantly being improved by many experienced programmers. It is currently available for all major platforms. PHP is relatively easy to use. For example, PHP code can be embedded directly into an HTML file, whereas Perl and C require additional print statements to output HTML. Another advantage in using PHP is its native database support for an ever-increasing number of databases, thereby allowing access to the databases directly through SQL statements.

The above-described cache system has been successfully utilized with respect to the sharing of static data files in a shared memory system. However, the caching of dynamic files, such as those employed by the embedded scripting language PHP, in a shared memory system has not been achieved. More specifically, as described above, each request from a remote user activates a script on the server which calls files from the hard drive of the server and then translates and compiles them in regular memory into an intermediate code for satisfying the user's request. Taking data from the user's request, the intermediate code fulfills the operations, such as making database requests, to then generate an HTML page comprising the answer or response to the user's request which is sent to the user's computer. Once the response has been sent to the user, the intermediate code which was generated by the program files and was used to create the response to the user, is discarded, and not cached or otherwise saved for reuse. Thus multiple requests to run the same script requires multiple compilations of the intermediate code in order to satisfy each of the requests, even when the requests and their resulting intermediate code are identical. This is a terrible waste of processing power and time.

### SUMMARY OF THE INVENTION

Thus it is an object of the present invention to provide methods and apparatus for increased efficiency, adaptability and versatility in a computer system environment.

It is another object of the present invention to provide methods and apparatus for increased efficiency, adaptability and versatility in a computer network environment.

It is yet another object of the present invention to provide methods and apparatus for increased efficiency, adaptability and versatility in a Web site environment.

It is still another object of the present invention to provide methods and apparatus for increased efficiency, adaptability and versatility in a PHP Web site environment.

It is a further object of the present invention to provide methods and apparatus for creating cache mechanisms that yield increased server performance.

It is yet a further object of the present invention to provide methods and apparatus for expanding the ability to use cache memory for server processes.

It is still a further object of the present invention to provide a method and apparatus for caching to enable repeated use of the intermediate code products of server-side scripting languages.

These objects, and others not specified hereinabove, are achieved by an exemplary embodiment of the present invention, which comprises a script-caching module for dynamically caching the products of scripts generated by a scripting engine for running PHP code, thereby reducing response times for web sites. As such, it is particularly suited for web sites that run heavy-traffic applications. The dynamic cache of the present invention provides improved performance for cost-conscious and high-traffic business-oriented web sites that must process growing numbers of transactions within constantly shrinking time frames.

In general, it is more complicated to enable caching with shared memory, i.e. memory on a server which is accessed by multiple users, than it is to cache using regular memory. Regular memory is normally accessible only by a single process, i.e. the request comprising the script. By contrast, the product of a process stored in shared memory is accessible by several processes. The preferred embodiment of the present invention caches data structures, i.e. the intermediate code that has been generated by the server in regular memory, by moving the data structures to shared memory. In order to ensure that pointers are still pointing to valid addresses, the data structures cannot simply be moved en masse, i.e., in one block, because it is the nature of shared memory that all the pointers must be updated as part of the moving process, otherwise the pointers no longer point correctly.

The dynamic cache of the present invention works by storing an intermediate code product of a PHP script in the Web servers shared memory, instead of discarding the compiled scripts immediately after their execution, as is normally done in prior art systems. Since a compiled version of the PHP script is stored in the server's cache registry, redundant compilation operations are avoided, thus further reducing the load on the server, bypassing time-consuming accesses to the system disk, and reducing the load on the system processors. The system needs to recompile and save a new compiled version in the cache registry, only when the script is modified. The main purpose of the dynamic cache of the present invention is to increase transaction throughput, thereby improving server response time. Benefits include reducing overall system load, decreasing the amount of computer processing power required and improving profitability.

Use of the dynamic cache of the present invention results in significant improvements in a server's ability to accommodate multiple requests per second using a fraction of the computing resources normally associated with maintaining and operating high-traffic, business-based web sites.

### BRIEF DESCRIPTION OF THE DRAWINGS

In order to more fully understand the invention and to see how it may be carried out in practice, an exemplary embodiment will now be described, by way of non-limiting example only, taken together with reference to the accompanying drawings, in which:

FIG. 1 is a schematic block diagram illustrating users accessing Web servers through an electronic network, in accordance with an exemplary embodiment of the present invention;

FIG. 2 is a schematic block diagram illustrating the shared-cache memory of the present invention, in accordance with an exemplary embodiment of the present invention;

FIG. 3 is a flow chart of the dynamic shared-cache memory of the present invention adapted for use with PHP code script, in accordance with an exemplary embodiment of the present invention; and

FIG. 4, is a detailed flow chart of a shared memory replicator (SMR) in accordance with an exemplary embodiment of the present invention.

### DETAILED DESCRIPTION OF PREFERRED EMBODIMENTS

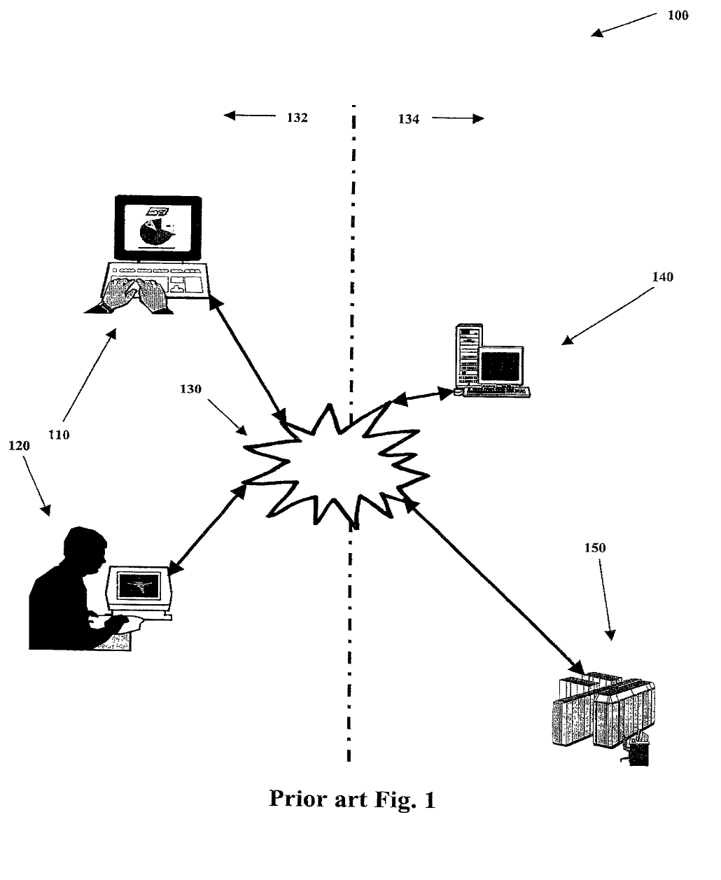

With reference to FIG. 1, which is a schematic block diagram illustrating users accessing Web servers through an electronic network 100, in accordance with the prior art, and showing an example of a small environment typical of those for which the present invention may be suitable for implementation.

User 110 and user 120 are shown sitting at their Web browsers and accessing the Internet 130. Internet 130 is shown as having a user/client side 132 and a server side 134. On server side 134 are shown Web site server 140 and Web site server 150. PHP: Hypertext Preprocessor (PHP) is the embedded scripting language used to create interactive Web pages, and is run on the Web servers themselves. Each Web server can generally be said to have [a] a long-term storage device, such as a hard drive; [b] regular memory, e.g. RAM where programs are executed after retrieval from the long-term storage device, areas of regular memory are only accessible by one process at a time; and [c] shared memory which is like regular memory except that multiple processes can access the same areas of shared memory without being aware of one another or without affecting one another, unlike regular memory.

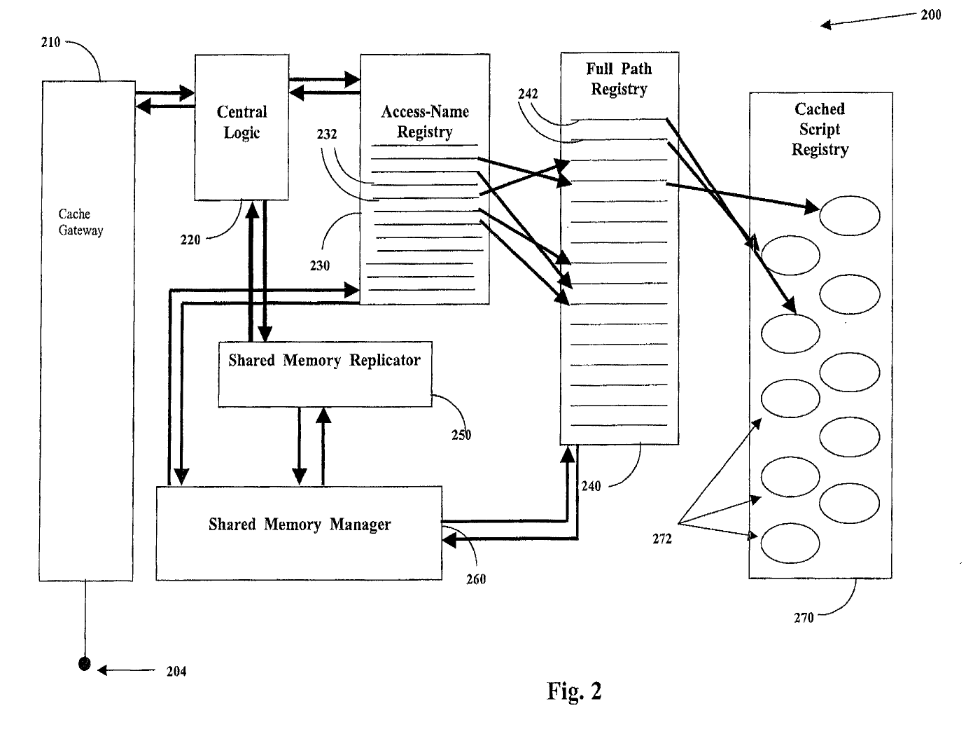

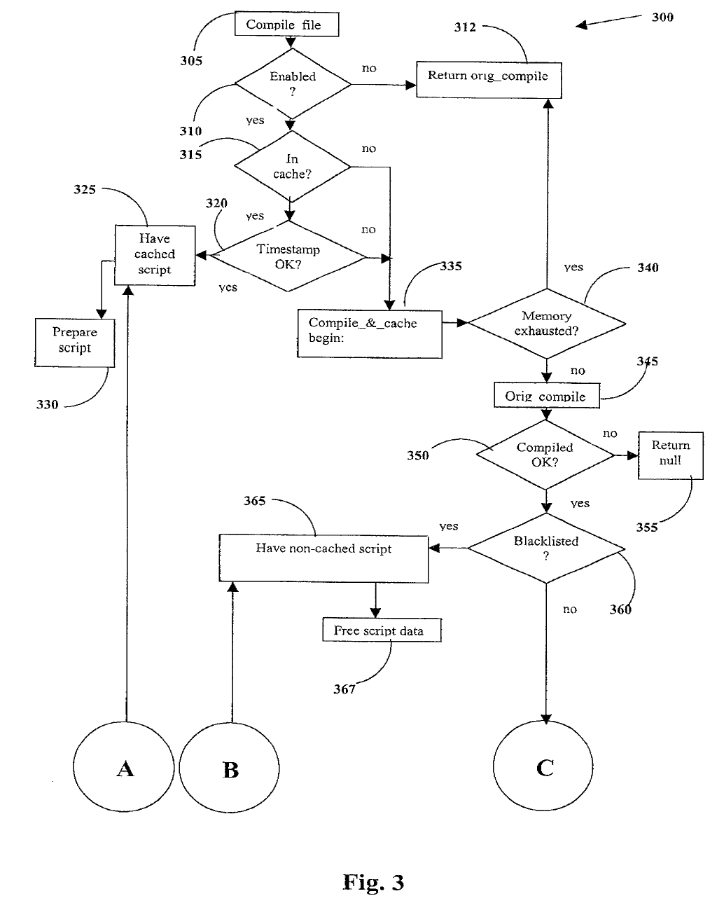

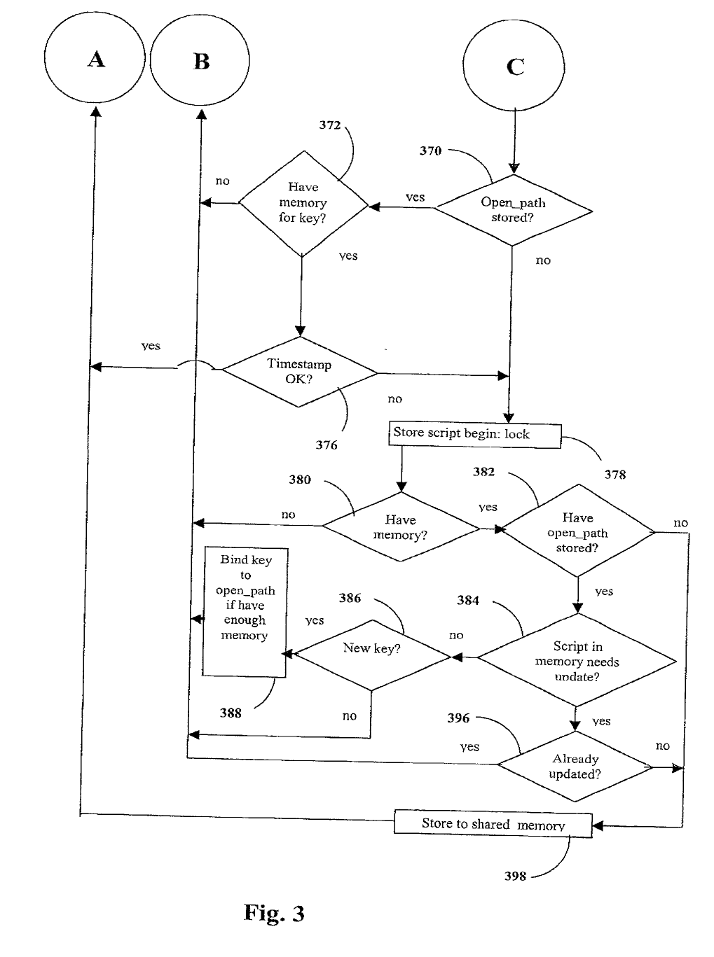

With reference to FIGS. 2 and 3, in accordance with an exemplary embodiment of the present invention, server 150 of network 100 is modified to include a script-caching module 200, to be used in conjunction with a scripting engine such as PHP, for example, and which works by taking the intermediate code which is the product when the scripting engine runs a script, and caching the intermediate code, i.e. the compiled product of the script, in the Web server's shared memory, instead of discarding the intermediate code immediately after the resultant HTML page (or other Web page type) has been sent to the remote user's computer as a response thereto.

In FIG. 2, an input port 204 to the cache gateway 210 is shown. Gateway 210 provides a user-configurable gate mechanism, which among other possibilities, can be used to specify what kind of files to submit for dynamic shared-cache operations. The first internal module is the central logic 220, and is designed for high-speed operation and database versatility, as detailed in FIG. 3 hereinbelow. Logic 220 begins by checking the access-name registry 230 to determine whether the compiled code is already in the cache script registry 270. Access-name registry 230 contains the relative path 232 of a cached file, and serves as a pointer to the corresponding entry in the full path registry 240. If relative path 232 is found in access-name registry 230, then the process is referred to shared memory manager 260 which refers to and retrieves the already compiled and cached version of intermediate code, thus saving considerable time as well as a disk access. Shared memory manager 260 refers to full path registry 240 for the following information which is stored in each entry thereof: [a] the full path name of the requested file's origin on the system's long-term storage device; [b] the timestamp of the shared-memory cached version of the compiled intermediate code; and [c] a pointer to the shared memory address of the first segment of the cached data structure comprising the compiled intermediate code. The full path name serves as the key for the full path registry 240. If access-name registry 230 does not contain a relative path 232 for the intermediate code of the requested script, then the process is directed to the normal execution of the script to generate the intermediate code product, which may subsequently be cached according to the caching process which will be described in greater detail hereinbelow. The first time a script is translated and intermediate code is compiled, shared memory manager 260, directs shared memory replicator 250 to copy each segment of the compiled intermediate code from regular memory to shared memory and to edit the pointers for each segment 272 saved in the cache script registry 270 portion of shared memory, to where requests will be referred to from the full path registry 240 when they are requesting segments of previously compiled intermediate code.

FIG. 3 is a flow chart of a process for using dynamic shared-cache memory 300, in accordance with an exemplary embodiment of the present invention. In block 305 a script is to be newly translated and compiled. If shared-memory cache look-up is not enabled 310, then a new compile 312 is performed with no further reference to shared memory until the next time the same request is made.

If look-up is enabled 312, then access-name registry 230 is examined in block 315 to determine whether the relative path appears there, indicating whether a copy of the compiled intermediate code is already stored in cache. If so, the timestamp of the new instance of the intermediate code which is being requested is checked 320 against the timestamp of the file already stored in cache, with reference to the full path registry 240. If the timestamps are the same, or if timestamp validation is turned off, then the cached compiled intermediate code 325 is used to prepare output 330, e.g. an HTML page to be sent to the remote user. In block 315, if it cannot be confirmed that the file is already in cache, or if the timestamps are not the same 320, then a new compile_and_cache process 335 is begun. Alternatively, if the dynamic shared-cache memory space is exhausted 340, then a new compile is performed 345. If the compilation is not OK 350, then a NULL (an error value) is returned 365, and the process is stopped.

In block 360 the requested relative path is checked against a “blacklist”, used to designate which files are rarely used and should not be cached 365 causing them to be filtered out by the cache gateway 210. The blacklist is among the features which can be user-configured and implemented by the cache gateway 210. If the compiled intermediate code is blacklisted, then it is simply used for generating the output and discarded 367. If the file is not blacklisted 360, then a check is made as to whether the full path of the compiled code is stored 370 in full path registry 240. If the full path is stored 370, then memory is checked for sufficiency to store the key 372. If memory is insufficient the non-cached compiled code 365 is used to generate the output script 367.

If memory is sufficient 372, then the timestamp of the script is checked 376 against the timestamp, stored in the full path registry 240, of a file already stored in cache. If the timestamps are the same then the cached script 325 is used to prepare the output script 330. In block 370, if it cannot be confirmed that the full path is stored, or the timestamps are not the same 376, then the store script process is begun 378 and the script is cached, i.e. a second version of the script is cached in addition to the first version.

If memory is not sufficient 380 for a full path registry 240 calculation, then the newly compiled file is not cached 365, and it 367 is used to make the output Web page. If memory is sufficient 380 then a check is made as to whether the full path is stored 378 in full path registry 240. If the full path is not stored 378, then the new compile is stored to shared memory 398, and the newly cached intermediate code 325 is used to prepare the Web page to be sent to the remote user 330.

If the full path is stored 378 in full path registry 240, it may be desirable to determine whether the script in memory needs an update 384 for instance, if the timestamp on the script file is newer than the timestamp that is stored in the cache, and whether the script in memory already has been updated by a parallel process 396. If already updated 396, then the newly compiled file is not cached 365, and it is used to generate the output 367. If the script in memory has not already been updated 396, then the new compile is stored to shared memory 398, and the newly cached intermediate code 325 is used to prepare the output 330.

If the intermediate code in shared memory does not need an update 384, then it needs to be determined whether a new key 386 is needed. A new key may sometimes be needed even if the intermediate code is in the cache, because, under certain circumstances several keys may point to the same cached intermediate code. If a new key 386 is needed, then it is created and linked to the relevant entry in the full path registry, provided that available memory is sufficient 388.

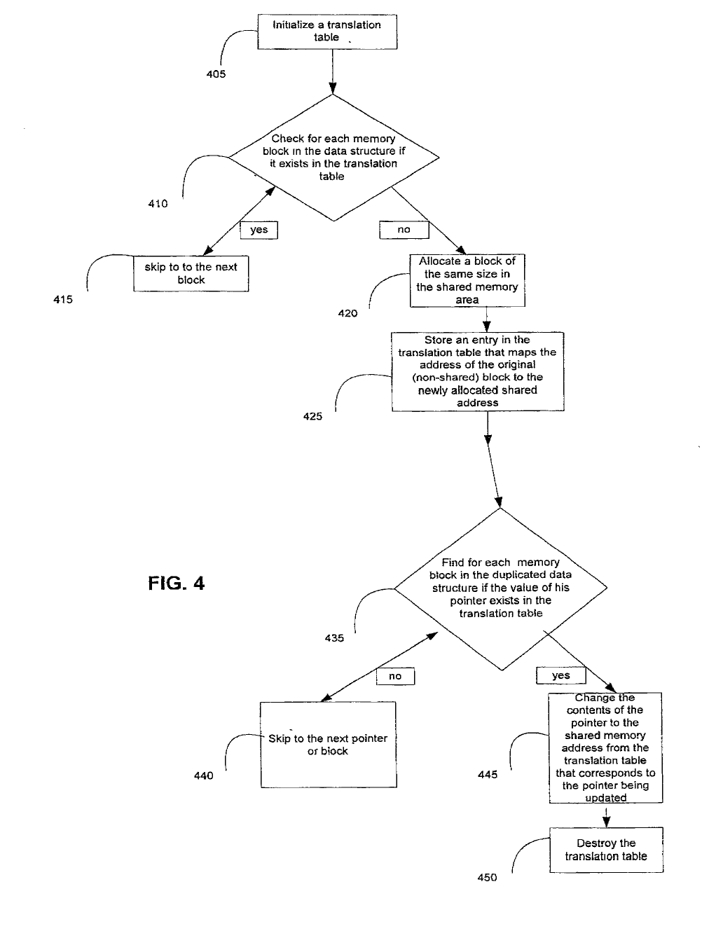

Referring now to FIG. 4, which is a more detailed depiction of the shared memory replicator (SMR) as mentioned in FIG. 2. The purpose of the SMR is to allow copying of data structures from regular memory into shared memory. Copying data structures by practices such as serialization structure can create serious complications when applied to copying data structures into shared memory. Using serialization structure for copying data structures into shared memory results in a static data structure. In such a case, simple functions such as searching the shared memory require resource intensive actions, such as un-serialization, and re-copying portions of the shared memory. To prevent such issues, the SMR creates and maintains a dynamic data structure, especially necessary in a shared memory environment.

The process of copying data structures from regular memory to shared memory is done in a unique way—such that at the end of the process, the duplicated shared data structure maintains the relationships between elements of the data structure in a way that the data construct remains intact. The SMR copies memory blocks of data structure from regular memory to new locations in shared memory and updates their pointers in a way that the resulting shared data structure remains usable, just as if it was the original, non-shared data structure.

The process starts by initializing a translation table which maps old addresses to new address 405. The next step is a direct copying of data structures, block by block from regular memory to shared memory. It starts by checking each memory block in the data structure if it exists in the translation table 410. If a memory block in the data structure doesn't exist in the translation table, a block is allocated in the shared memory area 420. In order to maintain the original connections between the blocks as they were in the non-shared memory area, entries that map the correlation of non-shared block memory addresses to the shared-memory addresses of the newly allocated shared blocks, are stored in the translation table 425. At the end of this process all the blocks from the non-shared memory have been placed into the shared memory, although their pointers still point to the original non-shared memory addresses.

In the next step the copying process is completed by updating the pointers with new shared memory addresses using a translation function. Step 435 checks if every memory address has already been transferred to the shared memory by looking it up in the translation table. If the pointer exists in the translation table the translation function is activated, changing the contents of the pointer to the shared memory address 445, and updating the translation table. If the pointer address has already been transferred, then the old memory address assigns a new memory address for where it has been transferred.

It will be appreciated that the preferred embodiments described above are cited by way of example only, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description, and which are not disclosed in the prior art. The scope of the invention shall only be determined by reference to the claims which follow.

What is claimed is:

1. A network server comprising shared memory and a cache mechanism for caching intermediate code files in said shared memory.

2. A network server according to claim 1, wherein said network server is a Web server.

3. A network server according to claim 1, wherein said cache mechanism comprises a shared memory replicator.

4. A network server according to claim 1, wherein said cache mechanism comprises a shared memory manager.

5. An intermediate code file according to claim 1, wherein said intermediate code is compiled from a PHP script.

6. A shared memory manager for caching intermediate code in shared memory.

7. A shared memory replicator for copying data structures into shared memory, wherein said data structure placed in said shared memory maintains the relationships between elements in said data structure in a way said data structure remains intact.

8. A process for caching intermediate code files in shared memory comprising the steps of:
receiving a script from an input port and sending said script to an scripting engine interface; determining whether an intermediate code product of said script is cached in said shared memory by checking an access-name registry compiling said script into an intermediate code;
and if said intermediate code does not exist in said cache script registry, copying said intermediate code from regular memory to shared memory;
and saving pointers for each segment saved in said share memory.

9. A process for maintaining and updating intermediate code files in cached shared memory comprising the steps of:
a. initializing a translation table for mapping old addresses to new address; and
b. copying said data structure from regular memory to shared memory; and
c. checking if memory blocks in said data structure exists in said translation table;
d. aqllocating a block in shared memory if said memory block doesn't exist in said translation table;
e. storing entries for mapping correlation of non-shared block memory addresses to a shared memory addresses of said allocated shared blocks in said translation table;
f. updating pointers with new shared memory addresses using a translation function;
g. checking if every memory address has been transferred to said shared memory using said translation table;
h. changing contents of pointer to said shared memory address if said pointer exists in said translation table;
i. updating said translation table.

10. The combination of a scripting engine and a shared-memory cache in which scripts from said scripting engine are cached.

11. The combination of claim 11, wherein said scripting engine is capable of servicing at least two processes concurrently.

12. The combination of claim 11, wherein said scripting engine is capable of re-caching a modified script.

13. The combination of claim 11, wherein the scripting engine resides in a server.

14. The combination of claim 11, wherein said scripting engine is a PHP scripting engine.

15. The combination of claim 11, wherein said scripting engine is a Perl scripting engine.

16. The combination of claim 11, wherein said scripting engine is a Python scripting engine.

17. The combination of claim 13, further comprising a network server.

18. The combination of claim 17, wherein said network server is a Web server.

19. The combination of claim 11, wherein the cache shared memory identifies that 2 labels refer to the same underlying file.

20. The combination of claim 11, wherein said scripting engine is capable of recognizing which files should not be cached.

21. The process according to claim 8, wherein said determining step comprises comparing the timestamp of said received script to the timestamp of a previously cached version of said script.

22. The process according to claim 8, wherein said received script is re-cached if the timestamp of said received script is different from the timestamp of said previously cached version of said script.

23. The process according to claim 13, further comprising referring to a full path registry to determine whether to recache a previously cached script.

24. The process according to claim 17, further comprising retrieving said cached script, using said full path according to an entry of said full path registry.

25. A shared memory replicator for copying data structure into shared memory, wherein said data structure maintains the original relationships between elements in said data structure such that the data structure remains intact and usable.
